(19) United States
(12) Patent Application Publication
(10) Pub. No.: US 2010/0190130 A1
(43) Pub. Date: Jul. 29, 2010

(54) DENTAL CURING TOOL WITH AUTOMATICALLY ROTATING LIGHT GUIDE

(76) Inventor: Robert J. LaRocque, Bedford, NH (US)

Correspondence Address: Vern Maine & Associates, 547 AMHERST STREET, 3RD FLOOR, NASHUA, NH, 03063-4000, US

(21) Appl. No.: 12/551,820

(22) Filed: Sep. 1, 2009

Related U.S. Application Data
(60) Provisional application No. 61/148,113, filed on Jan. 29, 2009.

(51) Int. Cl. A61C 3/00

(52) U.S. Cl. 433/29; 433/131

(57) ABSTRACT

A light-curing dental tool is disclosed that can apply curing light to an in-situ dental composite from variable and controllable directions, without removal of the tool from the patient's mouth. A light guide is rotated by a mechanical or electrical mechanism actuated by the operator's hand while grasping the tool, thereby redirecting the light while remaining within the patient's mouth, and while the operator maintains visual and physical contact with the patient. Rotation speed and direction can be controllable. Light guides can be interchangeable. A fixed or rotatable light guide receptacle can be included, and can be adapted for use with pre-existing light guides. Rotation mechanisms can include gears and/or drive belts. Electrical rotation mechanisms include an electric motor, and can include switches and or buttons. The tool can be powered from an electrical outlet, or by a battery that can be recharged by docking with a base station.

### RELATED APPLICATIONS

This application claims the benefit of U.S. Provisional Application No. 61/148,113, filed Jan. 29, 2009, incorporated herein by reference in its entirety for all purposes.

### FIELD OF THE INVENTION

The invention relates to dental tools, and more particularly to hand-held electrical dental tools.

### BACKGROUND OF THE INVENTION

Many dental procedures require the installation of a composite restoration or other light-cured material into a tooth within the mouth of a patient, followed by curing of the material using a light-curing device. The light-curing device typically includes a power source, either corded or rechargeable, a curing bulb or diode controlled by a switch of some type, and a “light guide,” which is typically a fiber-optic tube with a metal flange which is inserted into a receptacle in the light-curing device, and through which passes light of a wavelength necessary to polymerize the material which has been placed into the tooth. The light guide is typically rotatable, and includes a curved or bent end, so as to enable the curing light to be directed onto a specific region of a tooth from a specific direction.

The placement and curing of a dental composite material within a tooth typically requires multiple material insertions and/or multiple curing cycles, with the curing light being directed at different angles during different curing cycles so as to control and optimize the direction of curing of the material. The direction of curing is commonly oriented at right angles to the surface of the material being cured, so as to optimally direct the shrinkage commonly incurred during the polymerization of the composite material.

For example, in the completion of a core buildup on a tooth, a large quantity of composite material is often placed into the tooth all at once. The operator must then direct curing light onto this quantity of material from many angles and directions so as to complete the curing. Typically, light will be applied from one direction for one or two curing cycles, then the light guide will be manually rotated and light will be applied from another direction for one or two additional curing cycles, and so forth until curing is completed. Manually rotating the light guide requires that the operator remove the light guide from the patient's mouth, take his or her hands out of position, adjust the rotational angle of the light guide (often not precisely), and then return the light guide to the patient's mouth for the next curing cycle. Often, the patient will move, or even close his or her mouth during the manual light guide rotation, due to a lack of operator control and patient contact.

The necessity for the operator, or for a dental assistant, to rotate the light guide manually between curing cycles by removing it from the mouth, rotating the guide, replacing it near the tooth, adjusting the position of the operator's hand, arm, or wrist according to the surface to be cured, and completing the additional required curing cycle(s), wastes time and leads to loss of contact with the patient. Furthermore, the rotation of the light guide, if done by a dental assistant, requires exacting verbal communication with the operator, so as to obtain the desired light-guide position.

In addition, the required orientation of the light guide can often only be guessed at prior to placement into the patient's mouth, so that repeated attempts are sometimes required prior to commencing the next curing cycle.

What is needed, therefore, is a device that enables application of curing light to a dental composite in a patient's mouth from variable and controllable directions, with efficient and convenient variability of the curing direction, without need of removing the device from the patient's mouth, and without loss of patient contact.

### SUMMARY OF THE INVENTION

A light-curing dental tool is claimed that can be used to apply curing light to a dental composite in a patient's mouth from variable and controllable directions, without requiring removal of the included light guide from the patient's mouth, and without loss of patient contact. The light-curing tool includes a graspable body and a light guide, the light guide being rotatable by means of a rotating mechanism that can be actuated by the hand of an operator while the hand is grasping the graspable body of the tool. The rotating mechanism can be either purely mechanical, or can include an electric motor that is contained within the graspable body, the motor being operable by a control provided on the graspable body.

By enabling controllable rotation of the light guide while it remains within the patient's mouth, and while the operator's eyes remain trained on the work being performed, the claimed light-curing dental tool preserves patient control, minimizes operator movement and fatigue, optimizes light guide positioning, maintains patient isolation and positioning, maximizes quality, and minimizes curing time and effort.

In various embodiments, the light guide is removable, and a plurality of exchangeable light guides can be included, for example to provide different light guide sizes and/or shapes.

The graspable body of the claimed dental tool can include a light guide receptacle that is configured to support the proximal end of the light guide while the distal end of the light guide is located within the mouth of a patient. The receptacle can be configured so as to rotate with the light guide or so as to remain fixed while the light guide rotates within it. The rotating mechanism can be mechanically linked to the receptacle, or directly to the light guide. The mechanical linkage can include one or more gears and/or belts.

The light guide receptacle can be compatible with conventional light guides that are intended for manual rotation in conventional light-curing tools, or it can require use of light guides that are specifically configured to be compatible with the present invention. The rotational relationship between the receptacle and the light guide can be maintained by compatible shaping, such as square, hexagonal, or star-shaping, or the proximal end of the light guide can be frictionally grasped by the receptacle.

The claimed light-curing dental tool can be powered from an electrical outlet, or it can include one or more batteries that are recharged when the graspable body is docked with a base station. In various embodiments, the motor controller can include a slidable element and/or a pressable element, and can provide variable control of the direction and/or the speed of rotation of the light guide.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is perspective view of a typical light-curing tool of the prior art, with a light source that is powered from an electrical outlet;

FIG. 1B is a perspective view of a typical light-curing tool of the prior art, with a light source that is powered by batteries that can be recharged by connection to a base station;

FIG. 2A is a functional side view of an embodiment of the present invention that includes a rotational light guide controlled by an electric motor and a slidable switch located above the light source trigger;

FIG. 2B is a functional side view of an embodiment similar to the embodiment of FIG. 2A, but including a manually operated rotational adjustment mechanism instead of an electric motor.

FIG. 3A is a functional side view of an embodiment that includes a gear-driven light guide receptacle into which the proximal end of a removable light guide can be inserted;

FIG. 3B is a functional side view of an embodiment that includes a belt-driven light guide receptacle into which the proximal end of a removable light guide can be inserted; and

FIG. 4 is a functional side view of an embodiment that includes a stationary light guide socket configured to support the proximal end of a gear-driven rotatable light guide.

### DETAILED DESCRIPTION

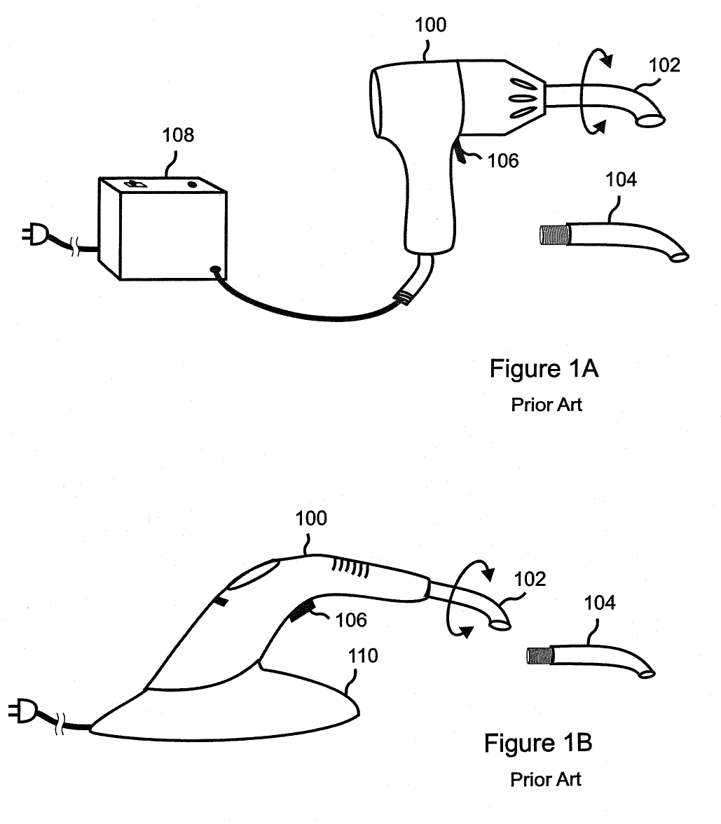

With reference to FIG. 1A, a typical light-curing dental tool of the prior art includes a graspable body 100 in which a light source is housed, and a manually rotatable light guide 102 that extends from the graspable body 100 and can be inserted into a patient's mouth so as to direct light from the light source onto a light-curable composite material located within the patient's mouth. The light guide 102 is manually rotatable, and includes a curved or bent end, so as to enable the curing light to be directed onto a specific region of a tooth from a specific direction. A light source trigger 106 extends from the graspable body 100, and can be actuated so as to turn the light source on and off. Typically, the light guide 102 can be removed from the graspable body 100 and replaced by a replacement light guide 104, so as to provide a variety of light guide sizes and/or shapes.

For the prior art tool of FIG. 1A, changing the rotational orientation of the light guide 102 requires that the tool be withdrawn from the patient so as to remove the light guide 102 from the patient's mouth. The operator then typically holds the graspable body 100 in one hand, while rotating the light guide 102 with the other hand. As a result, operator contact with the patient is interrupted, allowing the patient to change position, close his or her mouth, and such like. Manually rotating the light guide 102 in this manner also requires the operator to redirect his attention away from the patient's mouth, rather than remaining focused on the work area being cured. In addition, the operator, or an assistant, is typically required to guess as to the amount of the rotation that is required, so that more than one attempt may be needed before the next curing cycle can begin.

The light source of the prior art tool illustrated in FIG. 1A is powered by a power supply 108 that is connectable to a wall outlet. FIG. 1B illustrates a cordless, battery-powered light-curing tool 100 of the prior art that can be recharged by docking with a base station 110. The cordless tool 100 of FIG. 1B differs in shape from the tool of FIG. 1A, but includes most of the same features, except for the difference in power source. Some embodiments of the present invention include sizes, outward appearances, light sources, power sources, and/or other features that are similar to light-curing tools of the prior art, such as those illustrated in FIG. 1A and FIG. 1B.

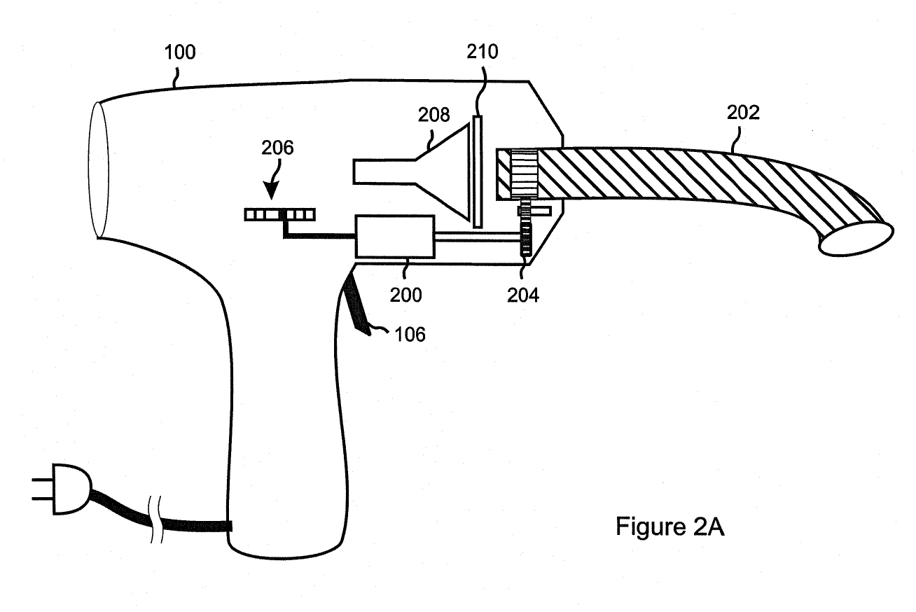

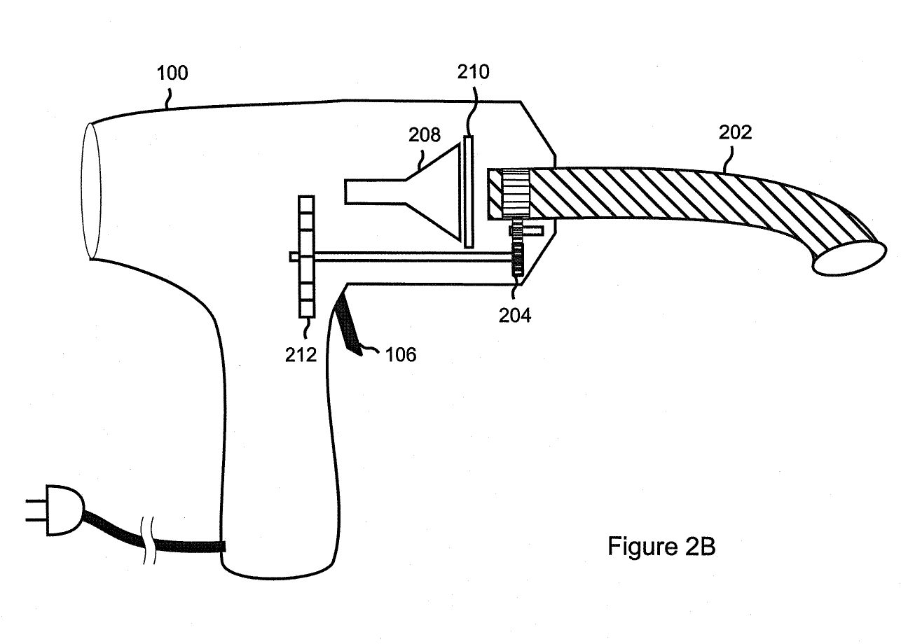

FIG. 2 is a functional side view diagram of an embodiment of the present invention. An internal electric motor 200 is rotationally coupled by gears 204 to a light guide 202, and is able to cause the light guide 202, to rotate to any desired rotational angle. The light guide 202 includes a curved or bent end, so as to enable the curing light to be directed onto a specific region of a tooth from a specific direction, depending on the orientation to which it is rotated. The motor 200 is actuated by a motor control switch 206, which is provided in a location on the graspable body 100 that can be conveniently reached by the thumb of an operator's hand while the hand is holding the graspable body 100. The motor control switch 206 is slidable in two directions so as to control the direction and speed of the rotation of the light guide 202. In other embodiments, the motor control switch is combined with the light source switch 106, so that both light illumination and light guide rotation are controlled by appropriate movements of the switch 106.

A light source 208 and wavelength limiting filter 210 are also shown in FIG. 2. The motor control switch 206 and motor 200 are configured so as to provide controllable starting and stopping of the rotational motion, thereby enabling an operator to easily rotate the light guide 202 to any desired orientation.

In some embodiments, the light guide 202 can be rotated while the light source 208 is illuminated during a curing cycle, while other embodiments include provisions that prevent simultaneous rotation of the light guide 202 and activation of the light source 208. For example, in certain embodiments the motor control switch 206 and the light source trigger 106 are interlocked, so that only one of them can be activated at any given time. In various embodiments, the mechanical linkage 204 and/or the motor is configured so as to physically inhibit rotational movement of the light guide 202 when the motor control switch 206 is not actuated. And in some embodiments, the functioning of the motor control switch 206 and motor 200 is similar to the functioning of mechanisms that provide automatic focusing in a camera.

In certain embodiments, the motor controller 206 includes features that allow the light guide 202 to be easily returned to one or more predefined orientations, such as a “home” orientation wherein the curved tip of the light guide 202 is aligned “downward,” in line with a handle of the graspable body. In similar embodiments, the motor control switch 206 includes feature that allow the light guide to be easily advanced between predetermined orientations, such as orientations separated by 90 degrees. In still other embodiments, the light guide includes features that allow the light guide to be advanced by predetermined angular rotations, such as rotations in 10 degree incremental steps.

For some embodiments that include rechargeable batteries, the motor 200 is configured for minimum power draw so as to conserve the energy of the battery.

In some embodiments of the present invention, rotation of the light guide is purely mechanical. For example, in the embodiment of FIG. 2B, an operator is able to adjust the rotation angle of the light guide 202 by manually rotating an adjustment wheel 212 protruding from the graspable body 100 and accessible to the thumb of a hand grasping the graspable body 100.

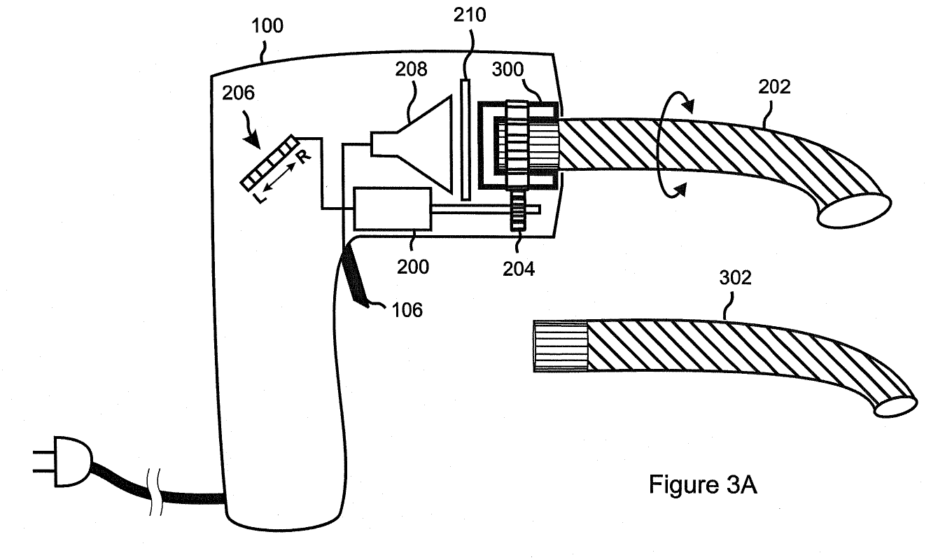

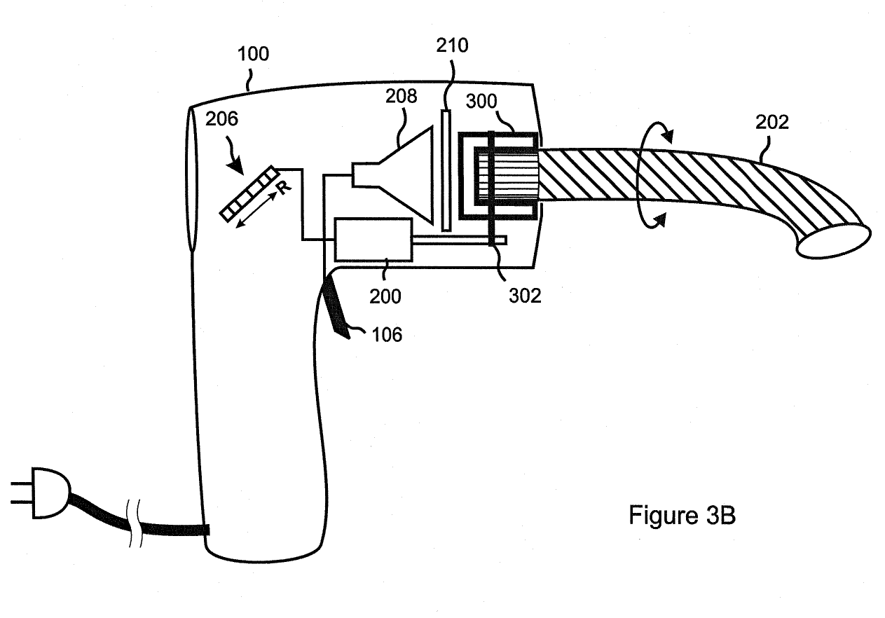

With reference to FIG. 3A, in some embodiments a light guide receptacle 300 is included in the graspable body 100. In the embodiment of FIG. 3A, the light guide receptacle 300 is in mechanical communication with the motor 200 through a pair of gears 204, and is configured to support the proximal end of the light guide 202 while the distal end of the light guide is inserted into the mouth of a patient. The light guide receptacle 300 allows the light guide 202 to be removed from the graspable body 100, and to be replaced by a replacement light guide 302, thereby enabling use of the embodiment with a variety of light guide sizes and/or shapes. In various embodiments, the light guide receptacle and the proximal end of the light guide rotationally interlock with each other due to compatible shaping, such as square, hexagonal, or star-shaping. In other embodiments, the proximal end of the light guide is frictionally grasped by the light guide receptacle.

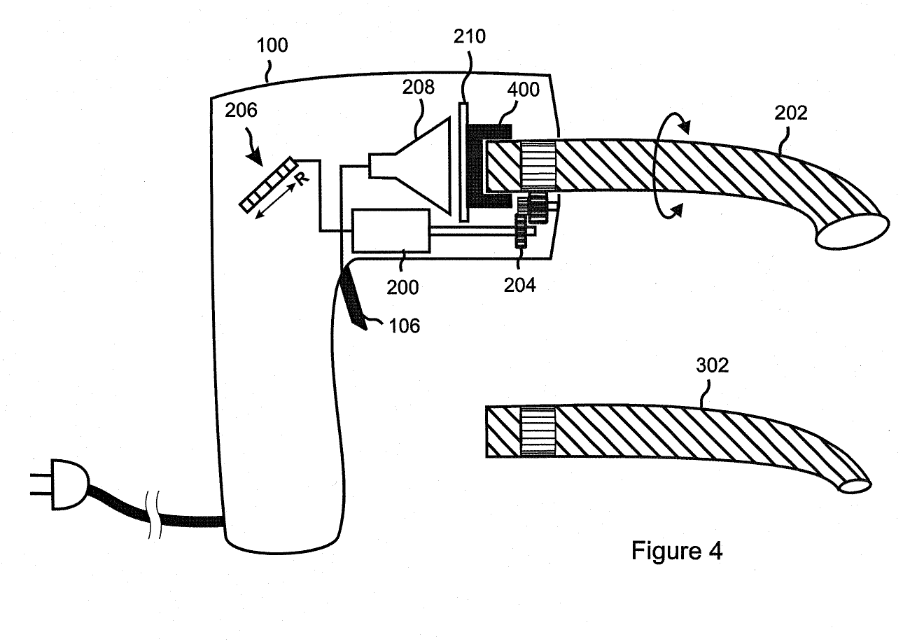

In certain embodiments, the light guide receptacle 300 is compatible with light guides 102, 104 intended for use with prior art light-curing tools that require manual rotation of the light guides 102, 104. In other embodiments, the light guide receptacle 300 is compatible only with light guides 202 specifically intended for use therewith. In FIG. 3A, the electric motor 200 is rotationally coupled to the light guide receptacle 300 by gears 204. FIG. 3B illustrates a similar embodiment, in which a belt 302 is used to couple the electric motor 202 to the light guide receptacle 300. FIG. 4 illustrates an embodiment that is similar to the embodiment of FIG. 3A, except that the light guide receptacle 400 is fixed in orientation and does not rotate. Instead, the light guide 202 is directly coupled by gears 204 to the electric motor 200, and the proximal end of the light guide rotates within the fixed receptacle 400.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A dental light-curing tool comprising:
a graspable body;
a light source contained within the graspable body;
a rotatable light guide configurable so as to direct light from the light source onto a light-curable dental material located within the mouth of a patient;
an electric motor contained within the graspable body, the electric motor being configured so as to cause the light guide to rotate when the electric motor is operated;
a power source configured so as to supply electrical power suitable for operating the electric motor; and
a motor controller positioned on the graspable body so as to be actuatable by a hand of an operator while the hand is grasping the graspable body, the motor controller being in electrical communication with the power source and with the electric motor so as to control operation of the electric motor when the motor controller is actuated by the hand of the operator.

2. The light-curing dental tool of claim 1, further comprising a light guide receptacle located within the graspable body and configured so as to receive and support a proximal end of the light guide while a distal end of the light guide is located within the mouth of the patient.

3. The light-curing dental tool of claim 2, wherein the light guide receptacle is rotatable by the electric motor, the light guide being fixable to the light guide receptical so as to rotate therewith.

4. The light-curing dental tool of claim 2, wherein the light guide receptacle is fixed in orientation within the graspable body, and the proximal end of the light guide is rotatable therein while being supported thereby.

5. The light-curing dental tool of claim 2, wherein the light guide is removably attachable to the light guide receptacle.

6. The light-curing dental tool of claim 2, wherein the light guide receptacle is compatible with a manual light guide, the manual light guide being intended for use with a manual dental tool that requires manual rotation of the manual light guide.

7. The light-curing dental tool of claim 1, wherein the electric motor is configured so as to mechanically communicate with the light guide through rotation of at least one of a gear and a drive belt.

8. The light-curing dental tool of claim 1, wherein the power source is configured so as to draw power from an electrical outlet.

9. The light-curing dental tool of claim 1, wherein the power source includes a rechargeable battery.

10. The light-curing dental tool of claim 9, further comprising a base station that is connectable to an electrical outlet, the base station being configured so as to recharge the battery when the graspable body is connected to the base station.

11. The light-curing dental tool of claim 1, wherein the motor controller is configured so as to allow control of at least one of a direction of rotation and a speed of rotation of the light guide.

12. The light-curing dental tool of claim 1, wherein the motor controller is actuatable by lateral movement of a control element.

13. The light-curing dental tool of claim 1, wherein the motor controller is actuatable by pressing upon a control element.

14. The light-curing dental tool of claim 1, wherein the light-curing dental tool is configured so as to prevent simultaneous rotation of the light guide and activation of the light source.

15. A light-curing dental tool comprising:
a graspable body;
a light source contained within the graspable body;
a rotatable light guide configurable so as to direct light from the light source onto a light-curable dental material located within the mouth of a patient;
a manually operated light guide rotation mechanism contained within the graspable body, the light guide rotation mechanism being configured so as to cause the light guide to rotate when the light guide rotation mechanism is manually operated; and
a rotation controller positioned on the graspable body so as to be actuatable by a hand of an operator while the hand is grasping the graspable body, the rotation controller being in rotational communication with the manually operated light guide rotation mechanism so as to cause the light guide to rotate when the rotation controller is actuated by the hand of the operator.

16. The light-curing dental tool of claim 15, further comprising a light guide receptacle located within the graspable body and configured so as to receive and support a proximal end of the light guide while a distal end of the light guide is located within the mouth of the patient.

17. The light-curing dental tool of claim 16, wherein the light guide receptacle is rotatable by the light guide rotation mechanism, the light guide being fixable to the light guide receptacle and rotatable therewith.

18. The light-curing dental tool of claim 16, wherein the light guide receptacle is fixed in orientation within the graspable body, and the proximal end of the light guide is rotatable therein while being supported thereby.

19. The light-curing dental tool of claim 16, wherein the light guide is removably attachable to the light guide receptacle.

20. The light-curing dental tool of claim 16, wherein the light guide receptacle is compatible with a manual light guide, the manual light guide being intended for use with a manual dental tool that requires manual rotation of the manual light guide.

21. The light-curing dental tool of claim 15, wherein the light guide rotation mechanism is configured so as to mechanically communicate with the light guide through rotation of at least one of a gear and a drive belt.

22. The light-curing dental tool of claim 15, wherein the light-curing dental tool is configured so as to prevent simultaneous rotation of the light guide and activation of the light source.
